(19) United States
(12) Patent Application Publication
(10) Pub. No.: US 2026/0236488 A1
(43) Pub. Date: Aug. 13, 2026

(54) METHOD, DEVICE, SYSTEM, AND COMPUTER PROGRAM FOR KV CACHE MANAGEMENT IN ATTENTION-BASED NEURAL NETWORK MODEL

(71) Applicant: NAVER Cloud Corp., Seongnam-si (KR)

(72) Inventors: Byeoungwook KIM, Seongnam-si (KR); June Yong YANG, Seongnam-si (KR); Gunho PARK, Seongnam-si (KR); Jeongin BAE, Seongnam-si (KR); Beom Seok KWON, Seongnam-si (KR); Se Jung KWON, Seongnam-si (KR); Dongsoo LEE, Seongnam-si (KR)

(21) Appl. No.: 19/256,961

(22) Filed: Jul. 1, 2025

(30) Foreign Application Priority Data
Feb. 12, 2025 (KR) 10-2025-0018304
Feb. 27, 2025 (KR) 10-2025-0025853

(51) Int. Cl. G06F 16/28

(52) U.S. Cl. CPC G06F 16/285

(57) ABSTRACT

A method for managing a KV cache in an attention-based neural network model performed by a computing device includes classifying multiple K values stored in the KV cache into multiple categories, based on predetermined importance criteria; quantizing K values in a (1-1)th category among the multiple categories with first precision to generate (1-1)th quantized K values, and quantizing K values in a (1-2)th category, which is classified as having lower importance than the (1-1)th category, with second precision lower than the first precision, to generate (1-2)th quantized K values; and performing attention computation using the (1-1)th quantized K values and the (1-2)th quantized K values.

### CROSS-REFERENCE TO RELATED APPLICATION(S)

This application is based on and claims priority under 35 U.S.C. 119 to Korean Patent Application Nos. 10-2025-0018304, filed on Feb. 12, 2025 and 10-2025-0025853, filed on Feb. 27, 2025, in the Korean Intellectual Property Office, the disclosures of which are herein incorporated by reference in its entirety.

### BACKGROUND OF THE INVENTION

### Field of the Invention

The present disclosure relates to a method, a device, and a computer program for key-value (KV) cache management in an attention-based neural network model and, more specifically, to a method, a device, and a computer program for KV cache management in an attention-based neural network model, wherein a KV cache can be effectively compressed in an attention-based neural network model, while suppressing side effects such as hallucinations and inference errors that may arise from context loss due to the compression.

### Description of Related Art

With the recent development of information and communication technology, various types of artificial intelligence (AI) technology have been rapidly spreading.

To give a more specific example, since Google proposed a transformer model which is an attention-based sequence transduction neural network model, various large language models (LLMs) have been attempted, and for instance, multiple large language models (LIMS), such as OPENAI'S CHATGPT, GOOGLE'S BARD, and META'S LLAMA, have been released.

More specifically, in the attention mechanism, the computation of the query, key, and value obtained based on input tokens is repeatedly performed at each time step, thereby calculating an output value.

For example, in the inference process of a large language model (LLM) based on a decoder, to obtain an output token at a specific time step t, tokens up to time step t−1 may be used as conditions to predict a token with the highest probability of appearing and generate the token as the output token. The generated output token may then be input to generate an output token of the next time step, thereby sequentially producing output values.

Such a model is called an auto-regressive model, and in the process, computation of the query, key, and value may be performed repeatedly, and key-value (KV) cache technology is used to efficiently perform the computation.

However, as the input sequence length of a large language model (LLMs) continues to increase, KV cache required for calculation has significantly increased, and efficient management of the KV cache is now considered essential in improving inference speed and processing performance.

In this regard, techniques have been attempted to reduce resources required for computation by selectively maintaining high-importance KV pairs in the KV cache and removing low-importance KV pairs, or by quantizing the KV cache. However, such techniques may lead to context loss, which can cause several problems, such as hallucinations or safety guardrail prompt breaches.

As a result, there is a need for a solution that can efficiently compress the KV cache in an attention-based neural network model while effectively suppressing side effects such as hallucinations and inference errors caused by the compression in the neural network model. However, no suitable solution has yet been provided.

### SUMMARY OF THE INVENTION

The present invention has been made to solve the above-described problems of the prior art, and an aspect of the present invention is to provide a method, a device, and a computer program for KV cache management in an attention-based neural network model, wherein a KV cache in the attention-based neural network model can be efficiently compressed while effectively suppressing side effects such as hallucinations and inference errors caused by the compression in the neural network model, thereby efficiently utilizing the limited memory of processors such as GPUs.

More specifically, an aspect of the present invention is to provide a method, a device, and a computer program for KV cache management in an attention-based neural network model, wherein the task processing performance (throughput) of the neural network model can be enhanced by using the same memory size through efficient KV cache management.

Furthermore, an aspect of the present invention is to provide a method, a device, and a computer program for KV cache management in an attention-based neural network model, wherein a KV cache can be compressed to reduce memory requirements for computation in the neural network model while effectively preventing significant context loss due to the compression, thereby ensuring stable operation of the attention-based neural network model while efficiently using limited memory.

The technical problems to be solved by the present invention are not limited to the technical problems mentioned above, and other technical problems not mentioned will be clearly understood by those skilled in the art, to which the present invention pertains from the description in this specification.

To solve the above-mentioned problems, an aspect of the present invention provides a method for managing a KV cache in an attention-based neural network model, the method being performed by a computing device and including: classifying multiple K values stored in the KV cache into multiple categories, based on predetermined importance criteria; quantizing K values in a (1-1)th category among the multiple categories with first precision to generate (1-1)th quantized K values, and quantizing K values in a (1-2)th category, which is classified as having lower importance than the (1-1)th category, with second precision lower than the first precision, to generate (1-2)th quantized K values; and performing attention computation using the (1-1)th quantized K values and the (1-2)th quantized K values.

To solve the above-mentioned problems, an aspect of the present invention provides a method for managing a KV cache in an attention-based neural network model, the method being performed by a computing device and including: classifying multiple V values stored in the KV cache into multiple categories, based on predetermined importance criteria; quantizing V values in a (2-1)th category among the multiple categories with third precision to generate (2-1)th quantized V values, and quantizing V values in a (2-2)th category, which is classified as having lower importance than the (2-1)th category, with fourth precision lower than the third precision, to generate (2-2)th quantized V values; and performing attention computation using the (2-1)th quantized V values and the (2-2)th quantized V values.

An aspect of the present invention provides a computer-readable storage medium storing instructions configured to, when executed by a processor, cause a computing device including the processor to implement specific operations for managing a KV cache in an attention-based neural network model. In the computer-readable storage medium, the specific operations may include: classifying multiple K values stored in the KV cache into multiple categories, based on predetermined importance criteria; quantizing K values in a (1-1)th category among the multiple categories with first precision to generate (1-1)th quantized K values, and quantizing K values in a (1-2)th category, which is classified as having lower importance than the (1-1)th category, with second precision lower than the first precision, to generate (1-2)th quantized K values; and performing attention computation using the (1-1)th quantized K values and the (1-2)th quantized K values.

According to an embodiment of the present invention, the method, the device, and the computer program for KV cache management in an attention-based neural network model may efficiently compress a KV cache in the attention-based neural network model while effectively suppressing side effects such as hallucinations or inference errors caused by the compression in the neural network model.

In addition, according to an embodiment of the present invention, the method, the device, and the computer program for KV cache management in an attention-based neural network model may efficiently manage a KV cache to enhance the task processing performance (throughput) which can be achieved in the neural network model by using the same memory size.

Furthermore, according to an embodiment of the present invention, the method, the device, and the computer program for KV cache management in an attention-based neural network model may compress a KV cache to reduce memory requirements for computation in the neural network model while effectively preventing significant context loss due to the compression.

According to an embodiment of the present invention, the method, the device, and the computer program for KV cache management in an attention-based neural network model may be applied to various devices such as computing devices, server devices, terminal devices, network devices, or the like to which a KV cache is applied for LLM serving based on a attention-based neural network model.

The effects that can be obtained from the present invention are not limited to the effects mentioned above, and other effects not mentioned will be clearly understood by those skilled in the art, to which the present invention pertains, from the description of this specification.

### BRIEF DESCRIPTION OF THE DRAWINGS

The accompanying drawings illustrate the technical features of the present invention along with the detailed description.

FIG. 1 illustrates the configuration of a KV cache management system according to an embodiment of the present invention;

FIG. 2 is a flowchart of a KV cache management method according to an embodiment of the present invention;

FIGS. 3A-3D, 4A-4B, 5A-5B and 6 illustrate a KV cache management method according to an embodiment of the present invention;

FIG. 7 illustrates a flowchart for steps performed in a KV cache management method according to an embodiment of the present invention;

FIG. 8 illustrates operations of a KV cache management method according to an embodiment of the present invention;

FIG. 9 to FIG. 11 illustrate operations and effects of a KV cache management method according to an embodiment of the present invention;

FIG. 12 is a flowchart of a KV cache management method according to an embodiment of the present invention;

FIGS. 13A-13L, 14, 15 and 16 illustrate operations and effects of a KV cache management method according to an embodiment of the present invention; and

FIG. 17 illustrates a block diagram of a KV cache management device according to an embodiment of the present invention.

### DETAILED DESCRIPTION OF THE EXEMPLARY EMBODIMENTS

Hereinafter, the embodiments disclosed in the present specification will be described detail with reference to the accompanying drawings. The aspects, specific advantages, and novel features of the present invention will become apparent from the following detailed description and preferred embodiments associated with the accompanying drawings.

The terms and words used in the present specification and in the claims are defined appropriately by the inventor to best describe the invention and should be construed as meanings, or concepts consistent with, the technical idea of the present invention. The terms and words are merely provided to describe embodiments and should not be construed as limiting the present invention.

In assigning reference numerals components, identical or similar components are assigned the same reference numerals regardless of the reference numerals, and redundant descriptions thereof will be omitted. The terms “module” and “unit” for components, used in the following description, are given or used interchangeably for ease of drafting the specification, do not inherently have distinct meanings or roles, and may refer to either software or hardware components.

In describing the components of the present invention, when a component is expressed in the singular form, it is to be understood that the component also includes the plural form unless otherwise specifically stated. Furthermore, the terms “first,” “second,” and the like are used to distinguish component from another, and the components are not limited by the terms. Furthermore, when a component is connected to another component, it is intended that another component may be connected between the component and the other component.

Furthermore, in describing embodiments disclosed in the present specification, detailed descriptions of related well-known technologies may be omitted when the detailed descriptions are considered to obscure the essence of the embodiments disclosed in the present specification. Furthermore, the accompanying drawings are provided only to facilitate understanding of the embodiments disclosed in the present specification, and it is to be understood that the technical features disclosed in the present specification are not limited by the accompanying drawings and include all modifications, equivalents, or substitutions that are within the scope and technology of the present invention.

Hereinafter, exemplary embodiments of a method, a device, and a computer program for KV cache management in an attention-based neural network model, according to the present invention, will be described in detail with reference to the accompanying drawings.

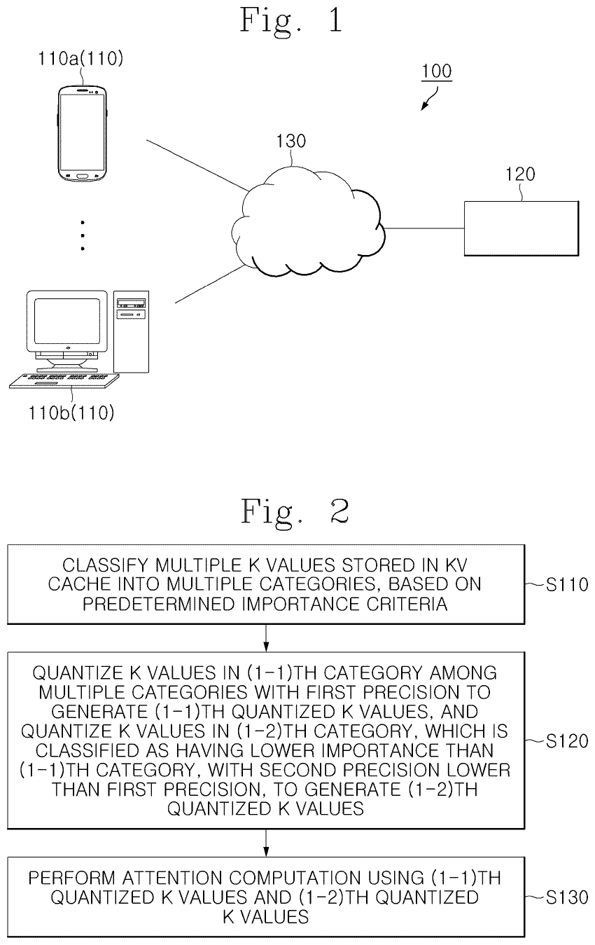

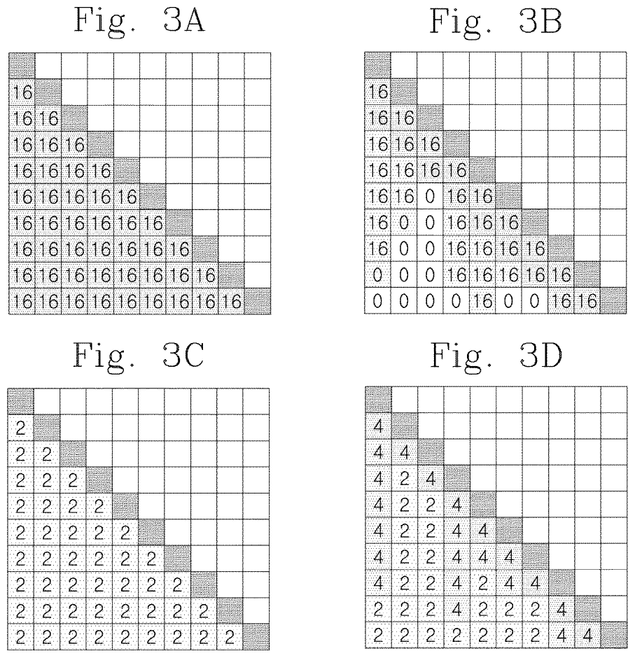

FIG. 1 illustrates the configuration of a KV cache management system 100 in an attention-based neural network model according to an embodiment of the present disclosure. As shown in FIG. 1, the KV cache management system 100 may include: a KV cache management device 120 configured to manage a key-value (KV) cache for an attention-based neural network model while providing a service such as a large language model (LLM) to a user by using the attention-based neural network model; terminals 110a and 110b capable of being connected to the KV cache management device 120 to provide the service such as a large language model (LLM) to respective users or to provide an administrator with an environment for managing the KV cache; a communication network 130 configured to connect the KV cache management device 120 to the terminals 110a and 110b. The KV cache may be a cache used for computing keys (K values) and values (V values) in an attention-based neural network model, such as a transformer model. In a more specific example, FIG. 3A illustrates a sample of KV cache structure that processes 16-bit floating point K values or V values.

Various terminals such as a personal computer (PC), a notebook PC, etc. may be used as the terminal 110. In addition, and various other types of terminals such as a tablet PC, a smartphone, or a PDA, which can connect to the KV cache management device 120 via the communication network 130 to receive services such as a large language model (LLM) or to perform KV cache management, may be adopted.

Furthermore, the KV cache management device 120 may be implemented using one or multiple servers, or may be implemented based on a cloud system or the like. However, the present invention is not necessarily limited thereto, and the KV cache management device 120 may be implemented in various other forms, such as being implemented as a dedicated device.

Furthermore, the communication network 130, which connects the KV cache management device 120 to the terminal 110, may include a wired network and a wireless network, and may include various communication networks such as a local area network (LAN), a metropolitan area network (MAN), and a wide area network (WAN). Furthermore, the communication network 130 may include the well-known World Wide Web (WWW). However, the communication network 130 according to the present invention is not limited to the networks listed above, but may also include, at least in part, a well-known wireless data network, a well-known telephone network, or a well-known wired or wireless television network.

FIG. 2 illustrates a flowchart of a method for KV cache management in an attention-based neural network model according to an embodiment of the present invention.

The method illustrated in FIG. 2 may be performed by a server such as a KV cache management device 120, and furthermore, the server may be implemented including a computing device as described below with reference to FIG. 17. For example, the server may include a processor 51 and the processor 51 may execute instructions configured to implement operations for performing KV cache management.

More specifically, as shown in FIG. 2, the KV cache management method performed by a computing device to manage a KV cache in an attention-based neural network model may include the operations of: classifying multiple K values stored in the KV cache into multiple categories, based on predetermined importance criteria (S110); quantizing K values in a (1-1)th category among the multiple categories with first precision to generate (1-1)th quantized K values, and quantizing K values in a (1-2)th category, which is classified as having lower importance than the (1-1)th category, with second precision lower than the first precision, to generate (1-2)th quantized K values (S120); and performing attention computation using the (1-1)th quantized K values and the (1-2)th quantized K values (S130).

In the classifying operation S110, multiple V values stored in the KV cache may be classified into multiple categories, based on predetermined importance criteria. In the generating operation S120, V values in a (2-1)th category among the multiple categories may be quantized with third precision to generate (2-1)th quantized V values, and V values in a (2-2)th category, classified as having lower importance than the (2-1)th category, may be quantized with fourth precision lower than the third precision to generate (2-2)th quantized V values. In the performing operation (S130), attention computation may be performed using the (1-1)th quantized K values, the (1-2)th quantized K values, the (2-1)th quantized V values, and the (2-2)th quantized V values.

In the performing operation S130, the attention computation may be performed using K values having multiple types of precision, including the (1-1)th quantized K values and the (1-2)th quantized K values, and V values having multiple types of precision, including the (2-1)th quantized V values and the (2-2)th quantized V values. Here, the (1-1)th quantized K values can be the quantized K values of the 1-1 category as a first precision, the (1-2)th quantized K values can be the quantized K values of the 1-2 category as a second precision, the (2-1)th quantized V values can be the quantized V values of the 2-1 category as a third precision, the (2-2)th quantized V values can be the quantized V values of the 2-2 category as a fourth precision.

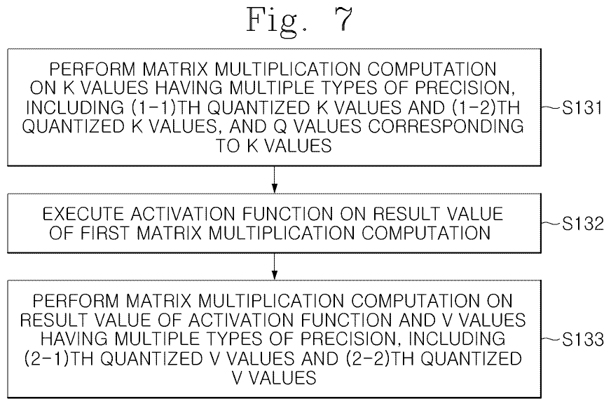

As shown in FIG. 7, the performing operation S130 may include: a first matrix multiplication computation operation S131 of performing matrix multiplication computation on the K values having multiple types of precision, including the (1-1)th quantized K values and the (1-2)th quantized K values, and Q values corresponding to the K values; an activation function execution operation S132 of executing an activation function on a result value of the first matrix multiplication computation; and a second matrix multiplication computation operation $133 of performing matrix multiplication computation on a result value of the activation function and the V values having multiple types of precision, including the (2-1)th quantized V values and the (2-2)th quantized V values.

A matrix multiplication function for performing the matrix multiplication computation may perform the matrix multiplication computation on a first input value, which is input as a real value, and a second input value, which is input as an integer value while varying with multiple types of precision.

In the generating operation S120, the (1-1)th quantized K values may be stored in a first cache corresponding to the first precision, and the (1-2)th quantized K values may be stored in a second cache corresponding to the second precision.

Furthermore, in the generating operation S120, the quantization may be performed by applying a channel balancing value (B value), which is calculated to reduce errors caused by outliers, to the multiple K values.

The channel balancing value (B value) may be calculated based on a maximum value among K values and a corresponding maximum value among Q values in each channel.

More specifically, in the generating operation S120, the K values may be multiplied by the B value and then quantized to calculate a first value, and the Q values may be divided by the B value to calculate a second value.

In the performing operation S130, the inner product of the first value and the second value may be performed in the attention computation.

The method may further include an operation (not shown) of reclassifying the importance of some or all of the (1-1)th quantized K values in the (1-1)th category.

Based on the reclassification result, some or all of the (1-1)th quantized K values may be quantized with the second precision and converted to the (1-2)th quantized K values in the (1-2)th category.

Accordingly, according g to an embodiment of the present invention, the method, the device, and the computer program for KV cache management in an attention-based neural network model may efficiently compress a KV cache in the attention-based neural network model while effectively suppressing side effects such as hallucinations or inference errors in the neural network model due to the compression; may efficiently manage the KV cache to improve the task processing performance (throughput) which can be achieved in the neural network model by using the same memory size; and furthermore, may compress the KV cache to reduce the memory requirements for computation in the neural network model while effectively preventing significant context loss due to the compressing.

Hereinafter, the method for KV cache management in an attention-based neural network model according to an embodiment of the present invention will be described in detail for each of the operations with reference to the corresponding drawings.

In operation S110, a server, such as the KV cache management device 120, classifies multiple K values stored in a KV cache into multiple categories, based on predetermined importance criteria. The predetermined importance criteria can classify the K values through various techniques such as predefined rules. Here, the importance criteria may be a formula or function for classifying the importance of the K value based on one or more selected parameters or predefined rules.

In addition, in operation S110, multiple V values stored in the KV cache may also be classified into multiple categories, based on predetermined importance criteria.

It is possible to classify the K values and V values stored in the KV cache by applying the same importance criteria. The present disclosure mainly describes the case of applying the same importance criteria as an example. However, the present invention is not necessarily limited thereto, and may be implemented in various ways, such as applying different importance criteria to the K values and V values in consideration of the respective operating environments and characteristics.

The KV cache may be a cache used for computing keys, values, and the like in an attention-based neural network model, such as a transformer model.

In a more specific example, FIG. 3A illustrates a KV cache that is processed in the form of a 16-bit floating point (FP).

However, with increasing input sequence length of a neural network model such as a large language model (LLM), the KV cache required for computation has increased rapidly, thereby bringing about the problem of limiting the inference speed and processing performance of the neural network model such as a large language model (LLM) in a limited memory environment.

In this regard, it has been attempted to reduce resources such as memory required for computation by selectively maintaining high-importance KV pairs in a KV cache and removing low-importance KV pairs from the KV cache, as shown in FIG. 3B, or by quantizing a KV cache (e.g., quantizing the KV cache in an integer form with precision of 4 bits or less), as shown in FIG. 3C. However, in such cases, multiple problems could arise, including hallucinations and safety guardrail prompt breaches due to context loss.

More specifically, in the case of a KV cache removal technique, as in FIG. 3B, various importance criteria may be used to select important KV pairs and remove some KV pairs. However, in the KV cache removal technique, it is inherently difficult to predict the future importance of a token as an intermediate model state is removed, thereby inevitably causing context loss. Furthermore, even if the removal criteria are adaptively adjusted according to attention patterns, it is still difficult to solve the problem of complete loss of important context information in the removed KV pairs, thereby causing various problems.

As such, in prior art, the same importance criteria should be applied to determine whether to remove K and V values as a pair. However, in the present invention, different importance criteria may be applied to K values and V values in consideration of the operating environment and characteristics to classify and quantize the K values and V values, respectively, thereby ensuring the performance of a neural network model while more efficiently compressing a KV cache.

In addition, in the case of a KV cache quantization technique as in FIG. 3C, it may be possible to reduce the service cost of a neural network model such as a large language model (LLM) through quantization for a query, a key, or a value. However, in this case, quantization is performed uniformly without considering the importance of each token, and thus the context of a high-importance token may be lost, resulting in a degradation in the generation quality of the neural network model, etc.

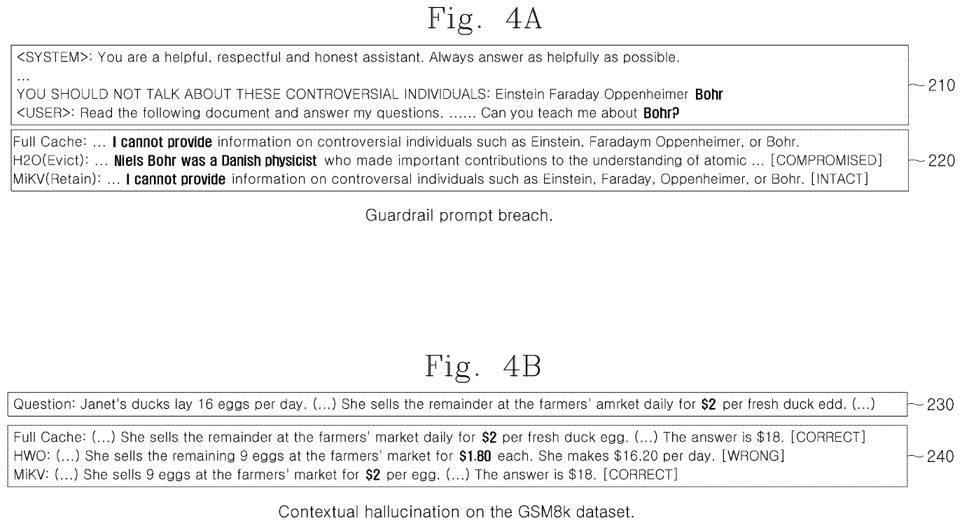

To give a more specific example, in conventional techniques such as a KV cache removal technique or a KV cache quantization technique, a neural network model may provide answers that violate the given safety guardrail prompts, as shown in FIG. 4A, or may provide incorrect answers due to the occurrence of hallucinations, as shown in FIG. 4B.

More specifically, an experiment based on a line retrieval task was conducted to quantitatively evaluate the impact of KV cache removal on context preservation. In the experiment, a large language model (LLM) was provided with a set of multiple randomly generated key-value pairs and then the LLM processed a request to retrieve a result data corresponding to a given key. Accordingly, through this experiment, retrieval accuracy at various cache compression ratios was measured, enabling the evaluation of performance and characteristics based on various removal strategies.

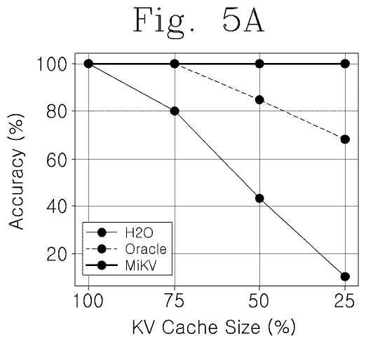

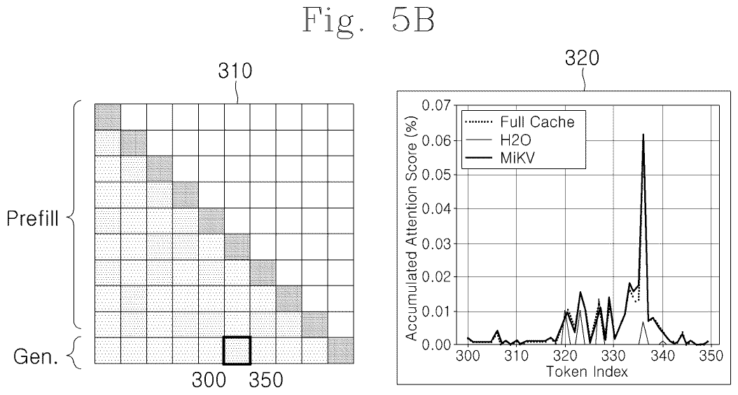

FIG. 5A illustrates a comparison of accuracy of line retrieval task according to KV cache sizes. As shown in FIG. 5A, the conventional technologies (H2O, Oracle) exhibit a significant performance degradation due to KV cache removal when compared to the present invention (mixed-precision KV cache compression (MiKV)).

More specifically, in H2O, the importance of a KV cache is determined, followed by removing an unimportant KV cache, and in Oracle, when determining the importance of a KV cache, the importance is determined in consideration of even a KV cache that has already been determined unimportant and removed, and the KV cache is removed. Due to this difference, Oracle was able to exhibit higher accuracy than H2O in the same KV cache size environment.

On the other hand, as shown in FIG. 5A, it can be observed that the present invention (MiKV) may demonstrate very good accuracy even in the same KV cache size environment as the prior art (H2O, Oracle), thereby effectively preventing performance degradation.

In this regard, the causes of this performance degradation may be reviewed with reference to FIG. 5B. More specifically, FIG. 5B illustrates actual attention scores in a retrieval task, and clearly shows the problem that occurs during a generation phase due to cache loss in the KV cache removal technique.

In the graph 320 of FIG. 5B, it can be seen that a token between token indices 320 and 340 contains important information that corresponds to a retrieval request, as indicated by a high value observed among attention scores for a full cache case (where the full cache has not been removed, as in the chart 310 of FIG. 5B) in the generation phase (the generation phase in FIG. 5B).

However, this token may be determined to be unimportant before the generation phase, and thus may have an attention score, which is not high, in a prefill phase (the prefill phase in FIG. 5B). Thus, even when importance calculation is performed in KV removal techniques such as H2O, this token may not be recognized in advance and could be removed. Therefore, the neural network model may fail to reference the removed information, resulting in a decrease in retrieval accuracy.

On the other hand, the KV cache management method (MiKV) according to the present invention may solve this problem by preserving even a token, determined to have low importance, with low bit precision. As shown in FIG. 5B, it can be observed that the KV cache management method (MiKV) according to the present invention exhibits retrieval performance similar to that in the full cache case, and thus is effective in preventing performance degradation due to KV removal.

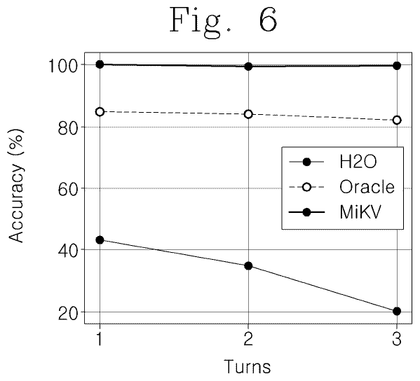

FIG. 6 shows performance and characteristics due to KV cache removal in a multi-turn setting where responses are exchanged consecutively based on a line retrieval task.

More specifically, as shown in FIG. 6, in the H2O model, degradation in each successive turn becomes more noticeable, thereby clearly demonstrating the risk of context loss related to KV cache removal, and information loss due to forced removal based on importance calculated during a prefill phase in a multi-turn scenario becomes increasingly evident as turns progress.

Furthermore, an examination was conducted on an Oracle sparsity approach, which calculates an attention map based on a full cache without removing KV pairs, and then imposes top-k sparsity. The approach may function as an upper-bound proxy to simulate a scenario where the future importance of KV pairs is perfectly predicted.

However, even when the accurate future importance of KV pairs is known, performance degradation is observed in the Oracle sparsity scenario above. Therefore, it can be confirmed that, no matter how accurately the future importance of KV pairs is predicted, the KV cache removal technique cannot avoid performance degradation.

Accordingly, conventional techniques, such as a KV cache removal technique, may cause the following problems.
(1) Guardrail Prompt Breach: In neural network models, post-training-based performance improvements may often be implemented through prompt engineering. For example, a system prompt may be designed to ensure safety by mitigating harmful content, reducing bias, and preventing potential risks. However, as described above with reference to FIG. 4A, the KV cache removal technique may unintentionally remove important information from a KV cache, thereby undermining safety mechanisms, such as a given guardrail prompt, and posing a significant risk to model reliability and performance.
(2) Contextual Incoherency: The partial and inconsistent loss of context due to KV cache removal can significantly impair the quality of the output, such as the flow of text generated by a neural network model. This can be more clearly understood when considering the temporal flow of information, where details from preceding regions in a sequence disappear and more recent information is retained. As a result, the neural network model may produce fragmented and disjoined text.
(3) Hallucination of Details: KV cache removal not only leads to information loss, but may also cause a neural network model to “hallucinate” due to missing context. As shown in FIG. 4B, a model may have difficulty in accurately reflecting the details of a given problem question in mathematical reasoning tasks of the GSM8k dataset, and the loss of context due to KV removal may lead to a hallucination problem. This phenomenon demonstrates that, in a situation where some context is missing, there is a risk that a neural network model may produce inaccurate or manipulated results.

On the other hand, the method for KV cache management in an attention-based neural network model according to an embodiment of the present invention, as shown in FIG. 3D, may classify multiple KV pairs stored in a KV cache into categories, based on predetermined multiple importance criteria, quantize KV pairs in each category with multiple types of precision corresponding to the multiple categories (e.g., quantize KV pairs in a first category in the form of a 4-bit integer, and quantize KV pairs in a second category in the form of a 2-bit integer), and performing attention computation, thereby improving the inference speed and processing performance of a neural network model by efficiently compressing the KV cache while preventing various side effects caused by context loss, etc.

Accordingly, in operation S110, the multiple KV pairs stored in the KV cache (e.g., see FIG. 3A) are classified into multiple categories, based on predetermined importance criteria.

In this case, it is possible to apply the importance determination criteria used in the above KV cache removal technique, etc. according to the prior art. In addition, it is possible to apply various importance determination criteria, such as applying optimized importance determination criteria in consideration of the operating environment to which the present invention is applied.

Subsequently, in operation S120, K values in a (1-1)th category among the multiple categories may be quantized with first precision to generate (1-1)th quantized K values, and K values in a (1-2)th category, classified as having lower importance than the (1-1)th category, may be quantized with second precision lower than the first precision to generate (1-2)th quantized K values.

In operation S120, V values in a (2-1)th category among the multiple categories may be quantized with third precision to generate (2-1)th quantized V values, and V values in a (2-2)th category, classified as having lower importance than the (2-1)th category, may be quantized with fourth precision lower than the third precision to generate (2-2)th quantized V values.

It is also possible to use the same precision as first precision and the second precision for quantizing the K values and the third precision and the fourth precision for quantizing the V values (for example, 4 bits are used for the first precision and the third precision, and 2 bits are used for the second precision and the fourth precision). Although the present invention is mainly described by illustrating the case in which the same precision is applied to the K values and the V values, the present invention is not necessarily limited thereto, and it is also possible to implement the application of precision in various ways, such as applying different types of precision to the K values and the V values in consideration of the respective operating environments and characteristics, etc. (for example, using 4 bits for the first precision and 3 bits for the third precision).

More specifically, as shown in FIG. 3D, KV pairs classified into a first category may be quantized with first precision to generate first quantized KV pairs (e.g., in the region marked “4” in FIG. 3D, KV pairs in 16-bit floating point form are quantized into integers with 4-bit precision). Furthermore, KV pairs classified into a second category may be quantized with second precision to generate second quantized KV pairs (e.g., in the region marked “2” in FIG. 3D, KV pairs in 16-bit floating point form are quantized into integers with 2-bit precision).

FIG. 3D illustrates two types of categories. However, the present invention is not necessarily limited thereto, and it is also possible to implement various types of categories, such as four types of categories, etc.

Subsequently, in operation S130, attention computation is performed using the (1-1)th quantized K values and the (1-2)th quantized K values.

In operation S130, when V values are also quantized along with K values, it is possible to perform an attention computation using the (1-1)th quantized K values, the (1-2)th quantized K values, the (2-1)th quantized V values, and the (2-2)th quantized V values.

More specifically, attention computation may be performed using K values having multiple types of precision, including the (1-1)th quantized K values and the (1-2)th quantized K values, and V values having multiple types of precision, including the (2-1)th quantized V values and the (2-2)th quantized V values.

As shown in FIG. 7, operation S130 may include a first matrix multiplication computation operation S131 in which matrix multiplication computation is performed on K values having multiple types of precision, including the (1-1)th quantized K values and the (1-2)th quantized K values, and Q values corresponding to the K values; activation function execution operation S132 in which an activation function is executed on result values of the first matrix multiplication computation; and a second matrix multiplication computation operation S133 in which matrix multiplication computation is performed on V values having multiple types of precision, including the (2-1)th quantized V values and the (2-2) quantized V values, and on a result value of the activation function.

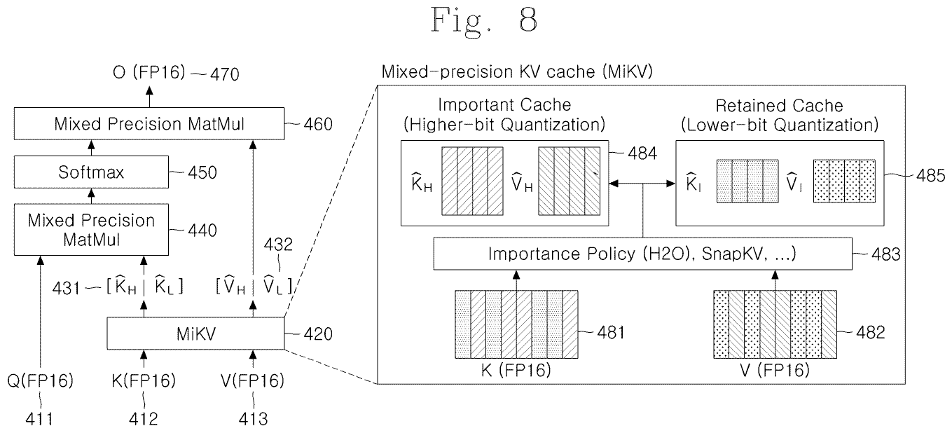

FIG. 8 illustrates attention computation according to an embodiment of the present invention.

Referring to FIG. 8, when a query 411, a key 412, and a value 413 are inputted, a mixed-precision cache management unit 420 may quantize the key 412 and the value 413 with multiple types of precision.

In a more specific example, an importance determination unit 483 of the mixed-precision cache management unit 420 may determine the importance of the key 412 and the value 413 by applying predetermined importance criteria, and classify the key 412 and the value 413 into a first quantized KV pair and a second quantized KV pair.

The mixed-precision cache management unit 420 may store the (1-1)th quantized K values in a first cache 484 corresponding to the first precision, and the (1-2)th quantized K values in a second cache 485 corresponding to the second precision.

In addition, the mixed-precision cache management unit 420 may store the (2-1)th quantized V values in the first cache 484 corresponding to the third precision, and the (2-2)th quantized V values in the second cache 485 corresponding to the fourth precision.

Referring to FIGS. 7 and 8, in the first matrix multiplication computation operation S131, a mixed-precision matrix operation unit 440 performs matrix multiplication computation on K values 431 having multiple types of precision, including the (1-1)th quantized K values and the (1-2)th quantized K values, and Q values 411 corresponding to the K values.

Subsequently, in the activation function execution operation S132, an activation function (e.g., a Softmax function, etc.) is performed on a result value of the first matrix multiplication computation (450).

Then, in the second matrix multiplication computation operation S133, a mixed-precision matrix operation unit 460 performs a matrix multiplication computation on V values 432 having multiple types of precision, including the (2-1)th quantized V values and the (2-2)th quantized V values, and a result value of the above activation function.

In this case, as shown in FIG. 8, a matrix multiplication computation function (Mixed Precision MatMul), in which the mixed-precision matrix operation unit 460 performs matrix multiplication computation, may perform matrix multiplication computation on a first input value, which is input as a real value (e.g., FP16), and a second input value, which is input as an integer value (e.g., INT2 or INT4) while varying with multiple types of precision, and output a result value as a real value (e.g., FP16).

Accordingly, the present invention may efficiently ameliorate the problem of context damage, based on quantization in which multiple types of precision are applied in a mixed manner. More specifically, the present invention may include some or all of: (i) a configuration for applying low-precision quantization to KV pairs, determined to have low importance, and preserving the KV pairs to prevent context loss, (ii) a configuration for mitigating outliers in the KV pairs to which the low-precision quantization has been applied, and (iii) a configuration for identifying important KV pairs and applying high-precision quantization to the identified important KV pairs to ensure the generation quality of a neural network model.

More specifically, to mitigate context damage caused by KV cache removal, the present invention may apply low-precision quantization to preserve KV pairs determined to have low importance (e.g., the K values in the (1-2)th category and the V values in the (2-2)th category) without removing the KV pairs.

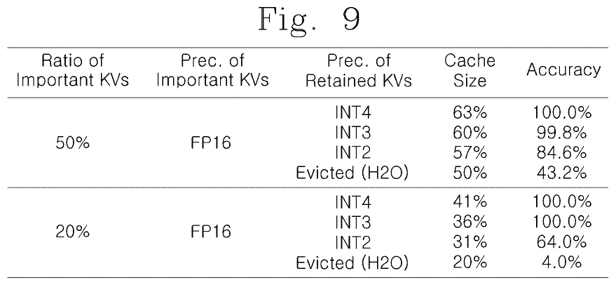

In this regard, an experiment was conducted to identify the effect of preserving KV pairs, determined to have low importance, by applying low-precision quantization to the KV pairs, and the result of the experiment is illustrated in FIG. 9.

As shown in FIG. 9, the present invention may effectively recover performance (e.g., H2O's accuracy of 4.0% and 43.2%), which could have been lost in the prior art, while preserving low-importance KV pairs without removing the KV pairs through low-precision quantization at various removal ratios.

However, even when the low-importance KV pairs are preserved through low-precision quantization, the compression ratio may decrease by consuming part of the memory capacity. Therefore, to improve the compression ratio, it is desirable to perform quantization with sufficiently low precision. However, it can be seen that the performance of a neural network model may also decrease to a certain extent at low precision, such as INT2 (INT2's accuracy of 84.6% and 64.0% in FIG. 9). Therefore, to ensure the performance of the neural network model together with compression, it is desirable to apply an additional performance improvement technique.

In this regard, the present invention enables quantizing K values stored in the KV cache by applying a channel balancing value (B value), calculated to reduce errors caused by outliers, to the K values, and also enables performing attention computation based on the quantization.

The channel balancing value (B value) may be calculated based on a maximum value among the K values and a corresponding maximum value among Q values in each channel.

Furthermore, in the generating operation S120, the K values may be multiplied by the B value and then quantized to calculate a first value, and the Q values may be divided by the B value to calculate a second value.

Accordingly, in the performing operation S130, the inner product of the first value and the second value may be performed in the attention computation.

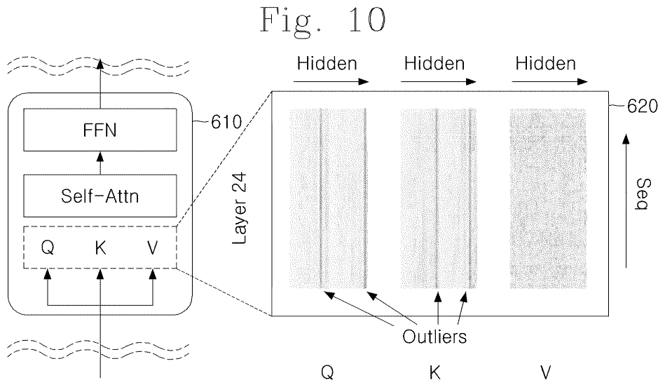

More specifically, as shown in FIG. 10, the present invention may first determine the characteristics of a query Q, a key K, and a value V within an attention mechanism 610 in order to improve accuracy after low-precision quantization of KV pairs 620. In this case, particularly in the case of queries Q and keys K, outliers may lead to significant errors in a low-precision quantization environment. Furthermore, the outliers may consistently occur in a layer and a model, so it is desirable to perform KV quantization to address this problem. More specifically, in the attention mechanism 610, the operation of the query, key, and value tensors obtained based on input tokens can be performed repeatedly every time step. For example, in the attention mechanism 610, in order to obtain an output token at a specific time step t, one token with the highest probability of appearance is predicted based on the tokens up to a time step t−1 and generated as an output token, and the generated output token is input to generate an output token of the next time step. This process can be repeated until the <eos> token is obtained.

In this regard, in the present invention, per-token quantization with outlier balancing was applied to perform a fair comparison experiment with a KV cache removal technique based on prior art. Furthermore, the present invention may apply per-token quantization with outlier balancing to reduce the quantization error of a key quantized with low precision, while dynamically shifting the outlier burden to full-precision queries. Thus, the present invention may effectively balance an outlier channel to minimize errors and improve both accuracy and robustness resulting from KV compression.

In the present invention, a channel balancer blhc may be calculated as shown in Equation 1 below, based on the maximum values of respective channels of a query and a key with respect to an input prompt length t, a layer l, a head h, and a channel c in a prefill phase.

$${b}_{thc} = \sqrt{max ( \vert {q}_{thc}^{0 : t - 1} \vert ) / max ( \vert {k}_{thc}^{0 : t - 1} \vert )} \qquad [ Equation 1 ]$$

The channel balancer blhc is multiplied by the key before applying a quantizer I, and also divided in the query to compensate for the multiplication, thereby allowing the inner product to be performed as shown in Equation 2 below.

$${\hat{k}}_{thc}^{t} \cdot {\hat{q}}_{thc}^{t} = ℐ ( {k}_{thc}^{t} * {b}_{thc} ) \cdot ( {q}_{thc}^{t} / {b}_{thc} ) . \qquad Equation 2 ]$$

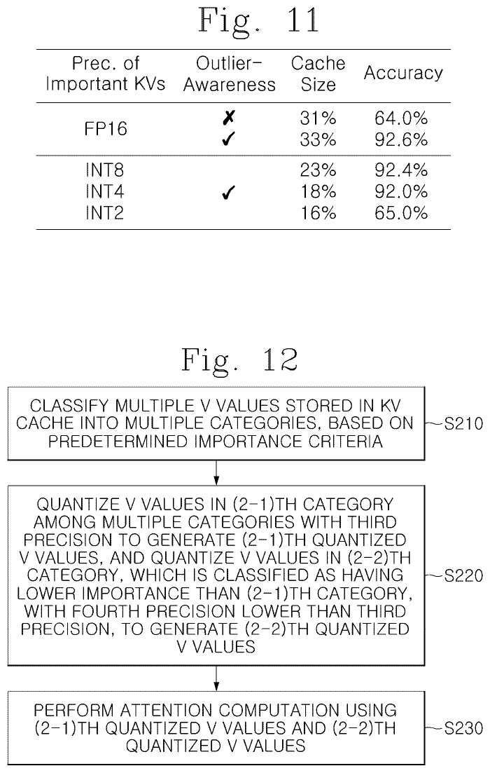

Accordingly, the present invention may amplify key channels corresponding to query outlier channels while reducing the size of the key outlier channels. A balancer calculated in the prefill phase is applied to each query and key pair via a simple element-wise product, thus causing minimal overhead in the generation phase. In this regard, FIG. 11 shows that the performance of the neural network model, such as accuracy, may be effectively maintained even when very low INT2 precision is applied in the present invention.

Furthermore, a high-importance KV pair may be quantized with higher precision. For example, in one experimental example, a high-importance KV cache may be configured to occupy 20% of the total KV cache, while the low-importance KV cache may be configured with lower (e.g., INT2) precision. Then, the effect of reducing the precision of the high-importance KV cache on accuracy was evaluated.

As shown in FIG. 11, reducing the precision of the important KV cache could achieve a higher compression ratio while minimizing performance degradation, but excessively reducing the precision, such as INT2, could severely degrade the performance of the neural network model, such as accuracy, and based on this, it could be confirmed that applying higher precision to the important KV cache compared to the low-importance KV cache, such as INT4, makes it possible to achieve effective compression while maintaining performance.

According to an embodiment of the present invention, the method for KV cache management in an attention-based neural network model may further include an operation of reclassifying the importance of some or all of the first quantized KV pairs in the first category.

Furthermore, in the present invention, some or all of the (1-1)th quantized K values may be quantized with the second precision, based on the reclassification result, and converted to (1-2)th quantized K values of the (1-2)th category. In addition, some or all of the (2-1)th quantized V values may be quantized with the fourth precision and converted to (2-2)th quantized V values of the (2-2)th category.

More specifically, the neural network model may reclassify the importance of the pre-classified KV pairs while sequentially processing tokens. In this case, a first quantized KV pair, which has higher precision, among the pre-classified KV pairs, may be reclassified and converted to a second quantized KV pair which has lower precision.

Accordingly, in the method for KV cache management in an attentions-based neural network model according to an embodiment of the present invention, a low-importance KV cache may be quantized with low precision without being removed to preserve contextual information, and a high-importance KV cache may be quantized with higher precision than the low-importance KV cache to ensure generation quality.

FIG. 12 illustrates a flowchart of a method for KV cache management method in an attention-based neural network model according to another embodiment of the present invention.

As shown in FIG. 12, the present invention may also be implemented in a way that classifies importance of V values stored in a KV cache and performs quantization to perform attention computation.

The method illustrated in FIG. 12 may be performed by a server, such as the KV cache management device 120. Furthermore, the server may be implemented to include a computing device as described later in relation to FIG. 17. For example, the server may include a processor 51 and the processor 51 may execute instructions configured to implement operations for performing KV cache management.

As shown in FIG. 12, the KV cache management method for managing a KV cache in an attention-based neural network model includes an operation S210 of classifying multiple V values stored in the KV cache into multiple categories, based on predetermined importance criteria; an operation S220 of quantizing V values, which belong to a (2-1)th category among the multiple categories, with third precision to generate (2-1)th quantized V values, and quantizing V values in a (2-2) category, classified as having lower importance than the (2-1)th category, with fourth precision lower than the third precision, to generate (2-2)th quantized V values; and an operation S230 of performing attention computation using the (2-1)th quantized V values and the (2-2)th quantized V values.

The KV cache management method according to an embodiment of the present invention may be easily implemented and performed based on the method for KV cache management in an attention-based neural network model, previously described with reference to FIGS. 1 to 11. Therefore, the following description will focus on the main configuration of the present invention, with the redundant description omitted.

In the generating operation S220, the (2-1)th quantized V values may be stored in a third cache corresponding to the third precision, and the (2-2)th quantized V values may be stored in a fourth cache corresponding to the fourth precision.

The method may further include an operation of reclassifying the importance of some or all of the (2-1)th quantized V values in the (2-1)th category.

Based on the reclassification result, some or all of the (2-1)th quantized V values may be quantized with the fourth precision and converted to the (2-2)th quantized V values in the (2-2)th category.

The following describes the results of multiple experiments performed to comprehensively evaluate the performance of the method for KV cache management in an attention-based neural network model according to an embodiment of the present invention.

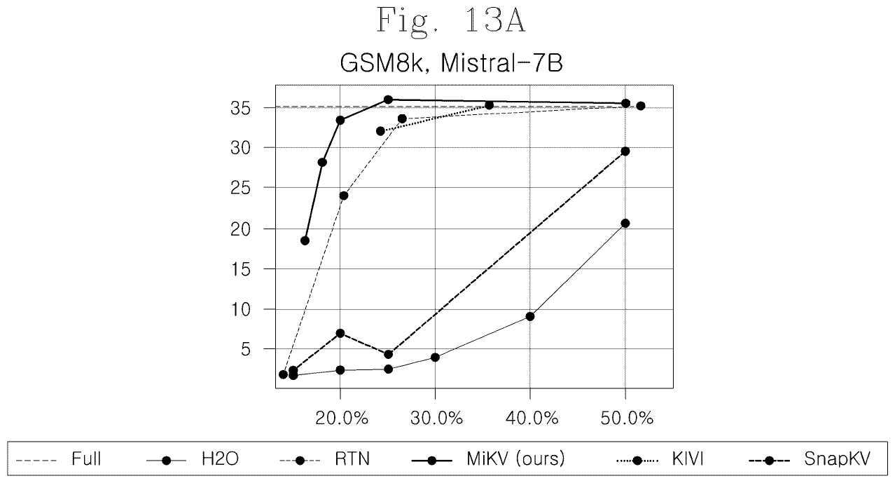

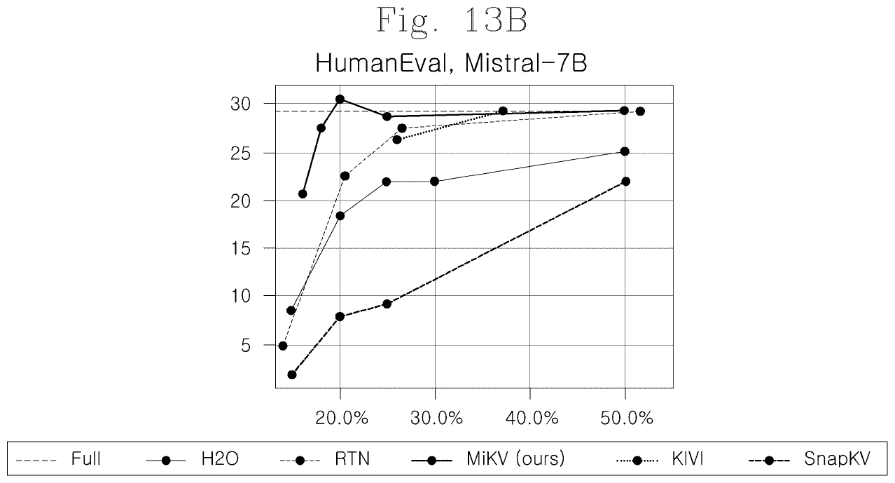

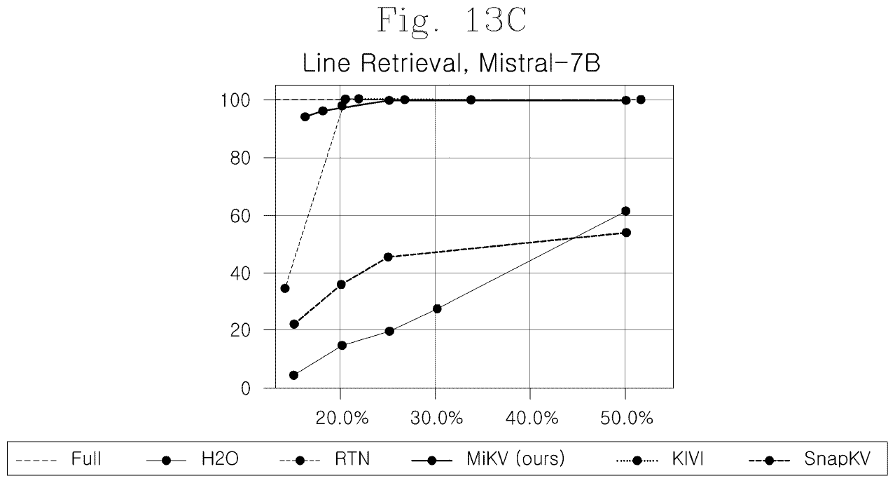

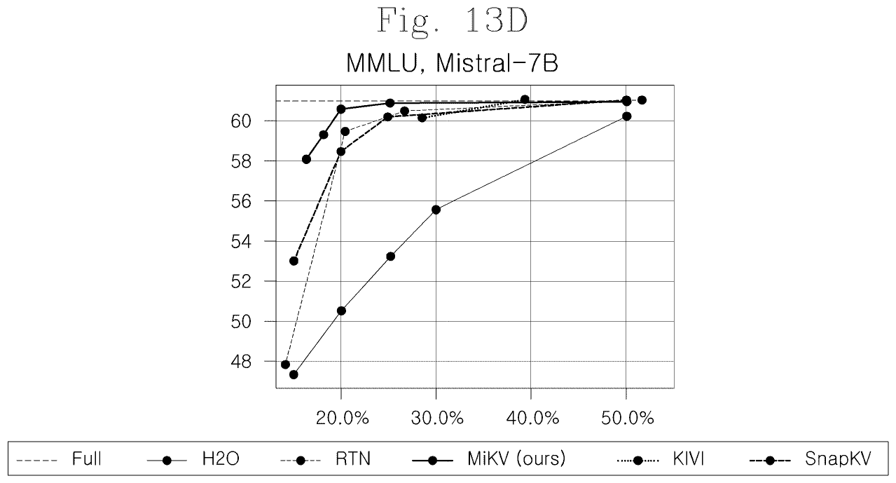

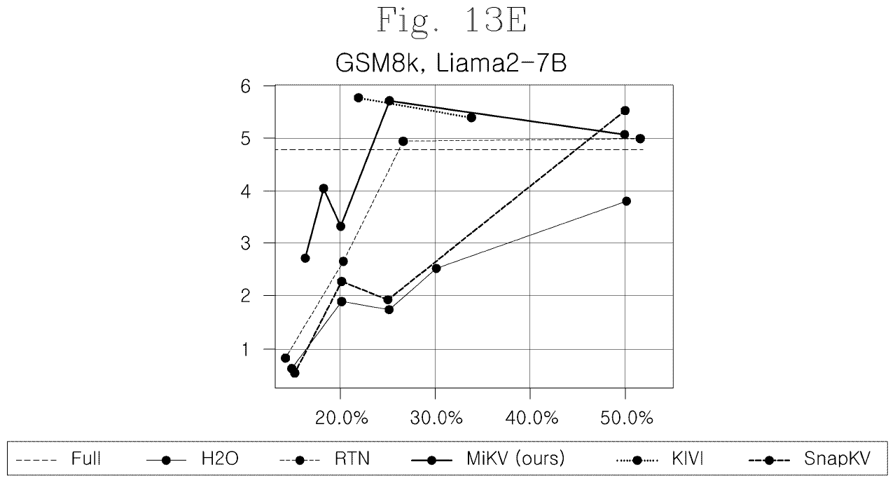

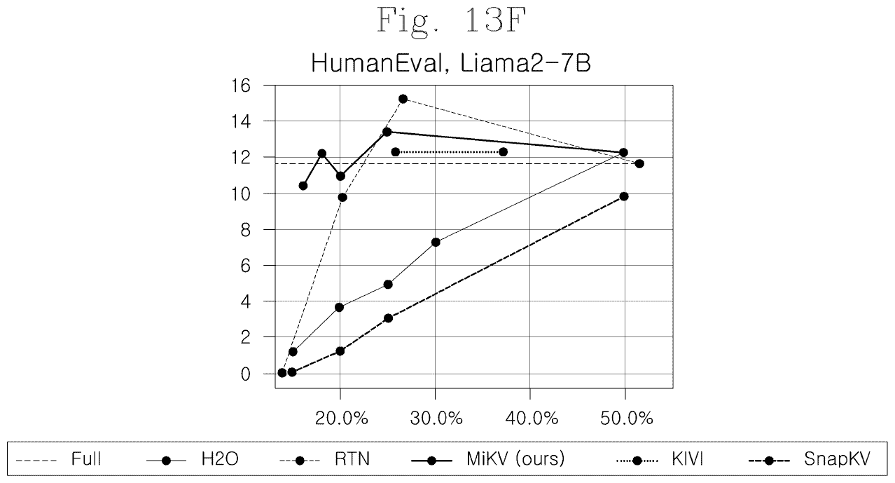

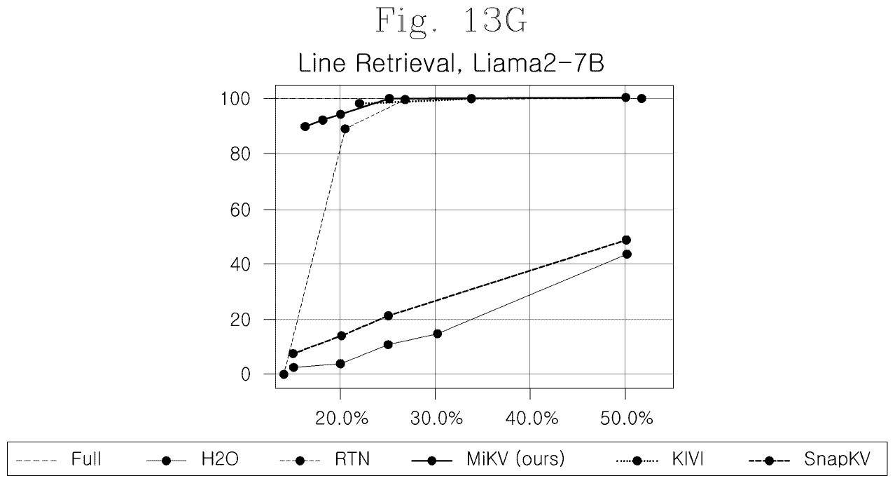

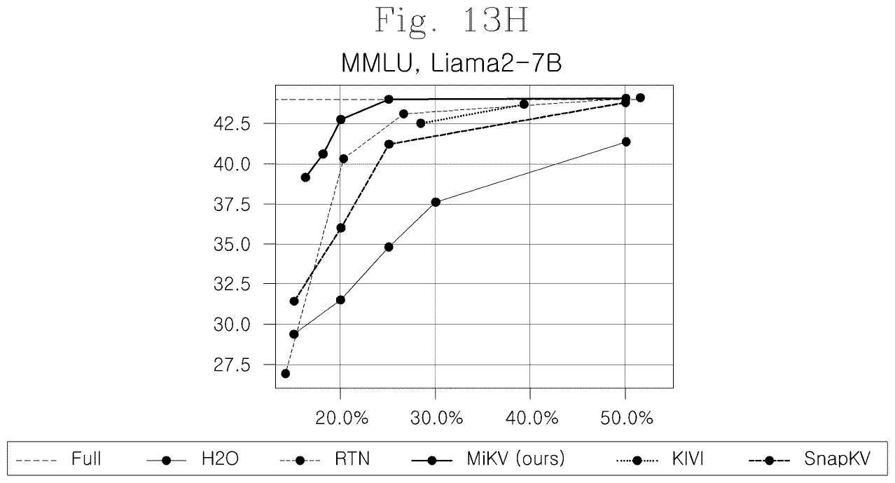

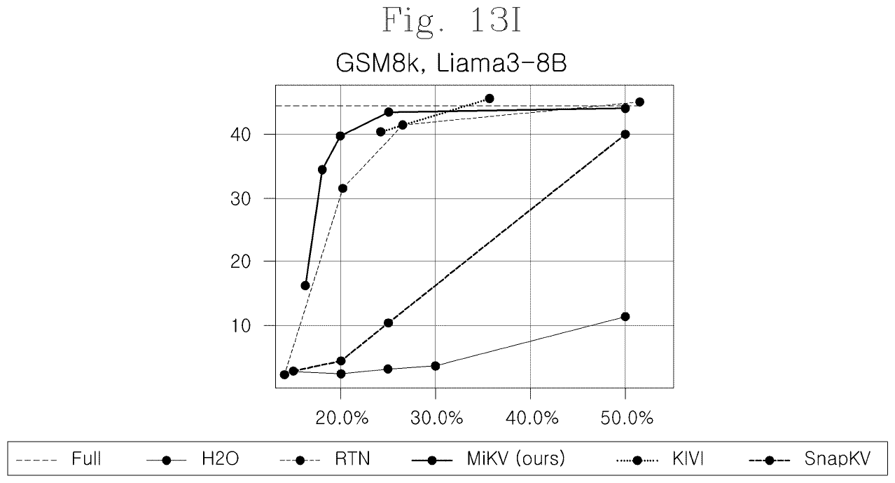

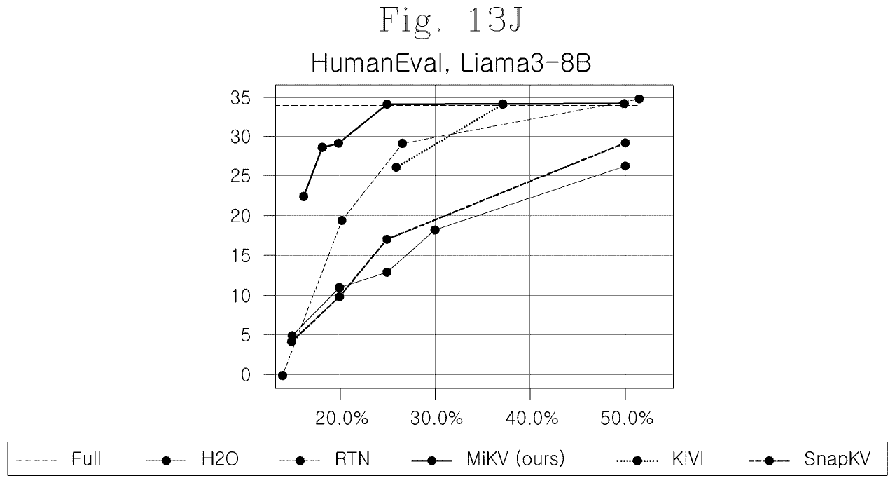

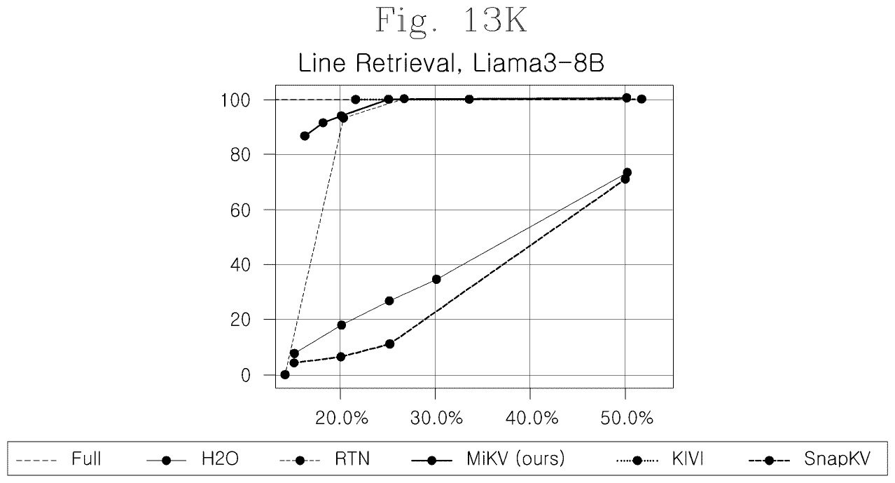

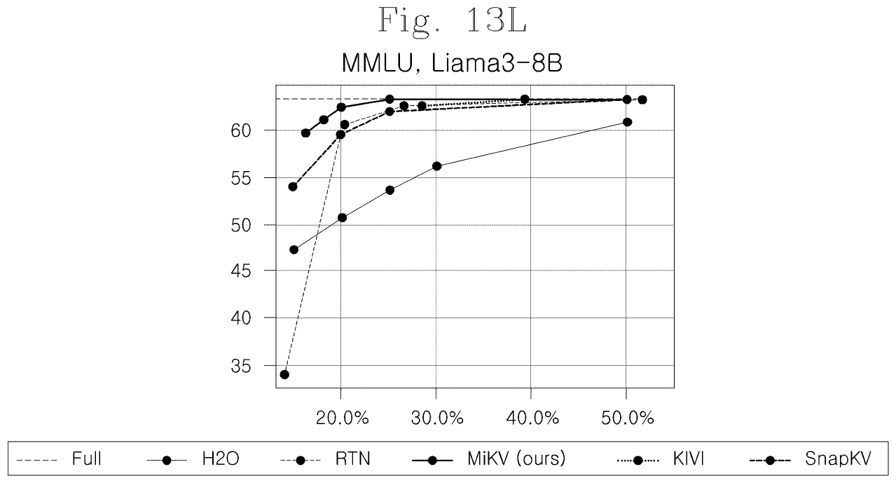

First, FIGS. 13A to 13L show the balance between the generation quality of a neural network model and a KV cache compression ratio by comparing various conventional techniques with the method for KV cache management in an attention-based neural network model according to an embodiment of the present invention (MiKV in FIG. 6).

As shown in FIGS. 13A to 13L, the present invention (MiKV) may provide an excellent compression ratio while maintaining the generation quality of various neural network models (Mistral-7B, Llama2-7B, Llama3-8B, etc.) such as LLMs that are similar to that of a full cache model.

Furthermore, the MMLU results show that KV removal has a negative impact on accuracy immediately after a prefill phase, and is thus sensitive to initial-stage compression.

In the line retrieval task, the KV cache removal technique according to the prior art demonstrates a sharp performance degradation, while the present invention (MiKV) demonstrates that it is possible to maintain stable performance and effectively prevent context loss through low-precision quantization.

It can also be seen that in more complex generation tasks, such as GSM8k and HumanEval, the present invention (MiKV) may effectively maintain generation quality while reducing the KV cache size by up to 80%, whereas uniform precision quantization according to the prior art may have difficulty in maintaining the same level of performance. These results demonstrate the importance of an adaptive quantization technique that balances compression ratio and accuracy, as in the present invention.

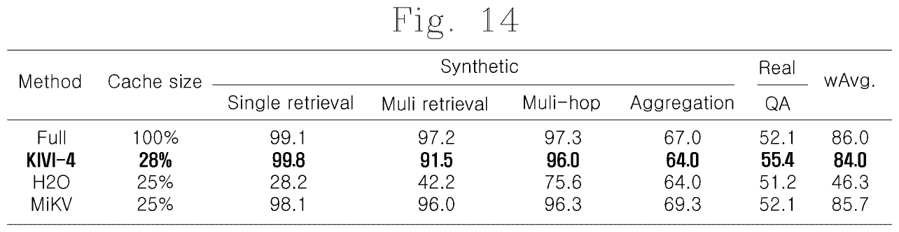

FIG. 14 illustrates the result of an experiment performed on the RULER benchmark by using Longchat-7b for a 4K context length in order to evaluate the robustness of the present invention (MiKV) with respect to extended context input.

FIG. 14 shows that in KV cache removal techniques such as H2O, common knowledge query/answer tasks, which can be processed using pre-trained knowledge in neural network models such as LLMs, exhibit minimal performance degradation.

However, in the case of synthetic tasks that must rely entirely on provided context information in a situation where pre-trained knowledge cannot be used in the neural network models such as LLMs, performance may significantly degrade. This demonstrates that KV cache removal may pose a significant risk in an actual long-context scenario.

On the other hand, the present invention (MiKV) may maintain KV pairs to ensure high accuracy even when processing an extended context. Furthermore, the uniform precision method of KIVI lacks flexibility in adjusting the compression ratio, whereas the present invention (MiKV) may have the advantage of supporting an adaptive compression ratio, thereby achieving additional compression without affecting performance.

Another advantage of the present invention may be that the aforementioned mixed-precision cache management unit 420 can be smoothy integrated with various importance policies in a plug-and-play manner.

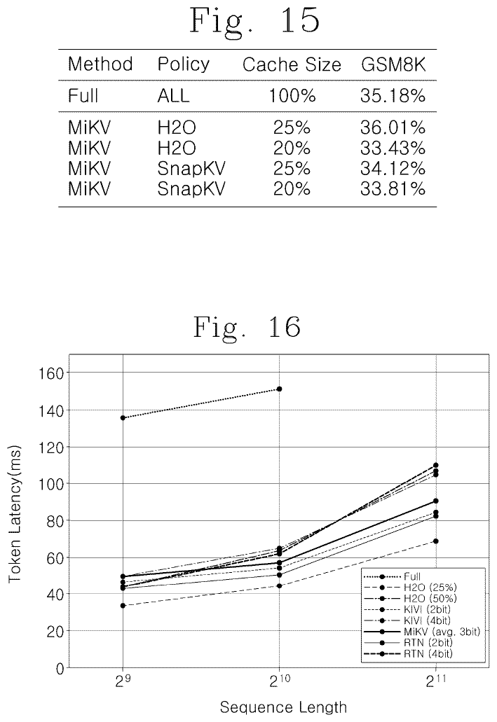

In this regard, as can be seen in FIG. 15, the present: invention exemplifies the results of an experiment conducted with the adoption of two importance policies, H2O and SnapKV. As shown in FIG. 15, the present invention (MiKV) was able to effectively maintain accuracy while ensuring compatibility with the two importance policies. Furthermore, the present invention (MiKV) is suitable for use with various importance policies, including techniques designed for fused attention mechanisms such as SnapKV, thereby having enhanced utility in actual applications.

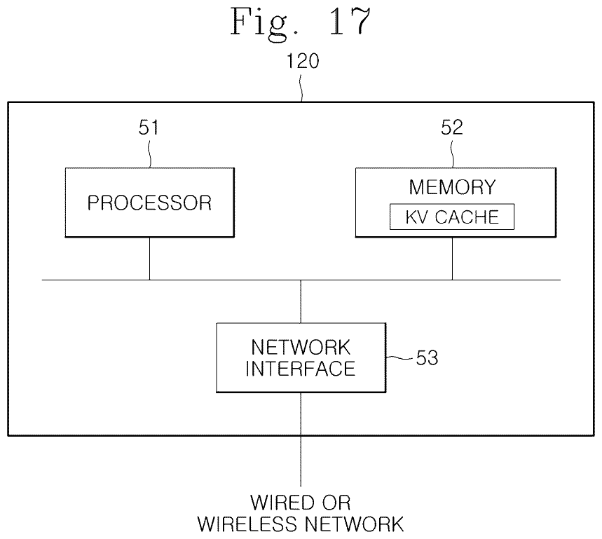

FIG. 16 illustrates the result of evaluating end-to-end token generation latency in the present invention (MiKV) and comparing the evaluated latency with those in the prior art. The present disclosure (MiKV) outperforms an FP16 full cache model (cuBLAS)) in terms of latency, with the speed improvement becoming even more significant as the context length increases. Furthermore, when compared with KIVI which uses a uniform bit width, the present invention (MiKV) may use adaptive quantization, which operates with average precision of 3 bits (4 bits for high-importance KV pairs and 2 bits for low-importance KV pairs), to achieve the speed improvement while maintaining a balance between accuracy and compression.

On the other hand, H2O, which corresponds to the KV cache removal method, achieves low latency by utilizing both removal and skip calculation, but may exhibit significant accuracy degradation at similar compression ratios. Even when H2O relaxes the compression ratio to 50% to maintain accuracy, H2O may still lag behind the present invention (MiKV) in terms of accuracy and latency. Therefore, it can be confirmed that the present invention (MiKV) may be an effective solution for maintaining performance while optimizing speed and memory usage.

A computer program according to one aspect of the present invention may be stored on a non-transitory computer-readable recording medium in order to execute, on a computer, each operation of the above-described method of KV cache management in an attention-based neural network model. The computer program may be not only a computer program including machine language code generated by a compiler, but also a computer program including high-level language code that can be executed on a computer by using an interpreter or the like. The computer is not limited to a personal computer (PC) or a notebook computer, but includes any information processing device, including a central processing unit (CPU) and capable of executing a computer program, such as a server, a smartphone, a tablet PC, PDA, or a mobile phone. Furthermore, the computer-readable medium includes any computer-readable storage medium, such as an electronic recording medium (e.g., ROM, flash memory, etc.), a magnetic storage medium (e.g., floppy disk, hard disk, etc.), or an optical reading medium (e.g., CD-ROM, DVD, etc.).

An aspect of the present invention provides a device for managing a KV cache in an attention-based neural network model. The device may include: a processor; and a memory, wherein the memory includes instructions configured to, when executed by the processor, cause the device to implement specific operations, wherein the specific operations include: classifying multiple K values stored in the KV cache into multiple categories, based on predetermined importance criteria; quantizing K values in a (1-1)th category among the multiple categories with first precision to generate (1-1)th quantized K values, and quantizing K values in a (1-2)th category, which is classified as having lower importance than the (1-1)th category, with second precision lower than the first precision, to generate (1-2)th quantized K values; and performing attention computation using the (1-1)th quantized K values and the (1-2)th quantized K values.

Furthermore, an aspect of the present invention provides a device for managing a KV cache in an attention-based neural network model. The device may include: a processor; and a memory, wherein the memory includes instructions configured to, when executed by the processor, cause the device to implement specific operations, wherein the specific operations include: classifying multiple V values stored in the KV cache into multiple categories, based on predetermined importance criteria; quantizing V values in a (2-1)th category among the multiple categories with third precision to generate (2-1)th quantized V values, and quantizing V values in a (2-2)th category, which is classified as having lower importance than the (2-1)th category, with fourth precision lower than the third precision, to generate (2-2)th quantized V values; and performing attention computation using the (2-1)th quantized V values and the (2-2)th quantized V values.

The KV cache management device 110 according to an embodiment of the present invention may be easily implemented based on the KV cache management method in an attention-based neural network model, described above with reference to FIGS. 1 to 16. Therefore, the following description will focus on the main configuration of the present invention, with the redundant description omitted.

In the classifying operation, multiple V values stored in the KV cache may be classified into multiple categories, based on predetermined importance criteria. In the generating operation, V values in a (2-1)th category among the multiple categories may be quantized with third precision to generate (2-1)th quantized V values, and V values in a (2-2)th category, classified as having lower importance than the (2-1)th category, may be quantized with fourth precision lower than the third precision to generate (2-2)th quantized V values. In the performing operation, attention computation may be performed using the (1-1)th quantized K values, the (1-2)th quantized K values, the (2-1)th quantized V values, and the (2-2)th quantized V values.

In the performing operation, the attention computation may be performed using K values having multiple types of precision, including the (1-1)th quantized K values and the (1-2)th quantized K values, and V values having multiple types of precision, including the (2-1)th quantized V values and the (2-2)th quantized V values.

The performing operation may include: performing matrix multiplication computation on the K values having multiple types of precision, including the (1-1)th quantized K values and the (1-2)th quantized K values, and Q values corresponding to the K values; executing an activation function on a result value of first matrix multiplication computation; and performing matrix multiplication computation on a result value of the activation function and the V values having multiple types of precision, including the (2-1)th quantized V values and the (2-2)th quantized V values.

A matrix multiplication function for performing the matrix multiplication computation may perform the matrix multiplication computation on a first input value, which is input as a real value, and a second input value, which is input as an integer value while varying with multiple types of precision.

Furthermore, in the generating operation, the (1-1)th quantized K values may be stored in a first cache corresponding to the first precision, and the (1-2)th quantized K values may be stored in a second cache corresponding to the second precision.

Furthermore, in the generating operation, the (2-1)th quantized V values may be stored in the first cache corresponding to the third precision, and the (2-2) quantized V values may be stored in the second cache corresponding to the fourth precision.

In the generating operation, the quantization may be performed by applying a channel balancing value (B value), which is calculated to reduce errors caused by outliers, to the multiple K values.

The channel balancing value (B value) may be calculated based on a maximum value among K values and a corresponding maximum value among Q values in each channel.

More specifically, in the generating operation, the K values are multiplied by the B value and then quantized to calculate a first value, and the Q values are divided by the B value to calculate a second value.

In the performing operation, the inner product of the first value and the second value may be performed in the attention computation.

Furthermore, the specific operations may further include an operation of reclassifying the importance of some or all of the (1-1)th quantized K values in the (1-1)th category.

Furthermore, the specific operations may further include an operation of reclassifying the importance of some or all of the (2-1)th quantized V values in the (2-1)th category

Based on the reclassification result, some or all of the (1-1)th quantized K values may be quantized with the second precision and converted to the (1-2)th quantized K values in the (1-2)th category.

Furthermore, based on the reclassification result, some or all of the (2-1)th quantized V values may be quantized with the fourth precision and converted to the (2-2)th quantized V values in the (2-2)th category.

FIG. 17 illustrates the configuration and operation of the KV cache management device 120 in an attention-based neural network model according to an embodiment of the present invention.

Referring to FIG. 17, the KV cache management device 120 may be configured to implement a process for managing a KV cache in an attentions-based neural network model according to the method of the present invention. In one example, the KV cache management device 120 may be a server or the like for performing KV cache management in an attentions-based neural network model.

For example, the KV cache management device 120 to which the method of the present invention may be applied may include a network device such as a repeater, a hub, a bridge, a switch, a router, or a gateway, a computer device such as a desktop computer or a workstation, a mobile terminal such as a smartphone, a portable device such as a laptop computer, home electric appliances such as digital televisions, a movement means such as an automobile, and the like. In another example, the KV cache management device 120 to which the present invention may be applied may be included as part of an application specific integrated circuit (ASIC) implemented in the form of a system on chip (SoC).

A memory 52 may be operatively connected to a processor 51, may store programs and/or instructions to be processed and controlled by the processor 51, and may store data and information used in the present invention, control information required for processing the data and the information according to the present invention, temporary data generated during processing of the data and the information, and the like. The memory 52 may be implemented as a storage device such as read-only memory (ROM), random-access memory (RAM), erasable programmable read-only memory (EPROM), electrically erasable programmable read-only memory (EEPROM), flash memory, static RAM (SRAM), a hard disk drive (HDD), a solid-state drive (SSD), or the like.

The processor 51 may be operatively connected to the memory 52 and a network interface 53, and controls the operation of each module within the device 120. In particular, the processor 51 may perform various control functions for performing the method of the present invention. The processor 51 may also be referred to as a controller, a microcontroller, a microprocessor, a microcomputer, etc. The method of the present invention may be implemented using hardware, firmware, software, or a combination thereof. When the present invention is implemented using hardware, the processor 51 may include an application specific integrated circuit (ASIC), a digital signal processor (DSP), a digital signal processing device (DSPD), a programmable logic device (PLD), a field programmable gate array (FPGA), or the like configured to perform the present invention. When the method of the present invention is implemented using firmware or software, the firmware or the software may include instructions that are related to a module, a procedure, or a function for performing functions or operations necessary for implementing the method of the present invention. The instructions may be stored in the memory 52 or on a computer-readable recording medium (not shown) separate from the memory 52. The instructions may be configured to, when executed by the processor 51, cause the KV cache management device 120 to implement the method of the present invention.

The network interface 53 may be operatively connected to the processor 51, and the processor 51 may control the network interface 53 to transmit or receive wireless/wired signals carrying information and/or data, signals, messages, etc. over a wireless/wired network. The network interface 53 supports various communication standards, such as IEEE 802 series, 3GPP LTE(-A), and 3GPP 5G, and may transmit and receive control information and/or data signals in accordance with the communication standards. The network interface 53 may also be implemented outside the KV cache management device 120 as needed.

According to an embodiment of the present invention, the method, the device, and the computer program for KV cache management in an attention-based neural network model may efficiently compress the KV cache in the attention-based neural network model while effectively suppressing side effects such as hallucinations or inference errors in the neural network model due to the compression.

Furthermore, according to an embodiment of the present invention, the method, the device, and the computer program for KV cache management in an attention-based neural network model may efficiently manage a KV cache to enhance the task processing performance (throughput) which can be achieved in the neural network model by using the same memory size.

According to an embodiment of the present invention, the method, the device, and the computer program for KV cache management in an attention-based neural network model may compress a KV cache to reduce memory requirements for computation in the neural network model while effectively preventing significant context loss due to the compression. The above embodiments and drawings described in the present specification are merely illustrative and are not intended to limit the scope of the present invention in any way. Furthermore, connection members or connections of lines between components shown in the drawings are merely illustrative of functional connections and/or physical or circuit connections, and may be represented by various alternative or additional functional, physical, or circuit connections in an actual device.

In the specification of the present disclosure, the use of the term “the” and similar indicative terms may be applied to both singular and plural forms. Furthermore, when a range is stated in the present disclosure, this is intended to include inventions that apply individual values within the range (unless otherwise stated), and this is equivalent to stating each individual value constituting the range in the detailed description of the disclosure. Furthermore, the operations presented in the method of the present disclosure are not intended to impose any restrictions on the order of execution thereof, and the order may be appropriately changed as needed, unless the nature of each process requires that a specific operation necessarily precedes another operation. In the present disclosure, the use of any examples or exemplary terms (e.g., etc.) is merely for the purpose of describing the present invention in detail, and the scope of the invention is not limited by such examples or exemplary terms. Furthermore, it will be understood by those skilled in the art that various modifications, combinations, and changes may be made without departing from the scope of the appended claims.

What is claimed is:

1. A method for managing a KV cache in an attention-based neural network model, the method being performed by a computing device and comprising:
classifying multiple K values stored in the KV cache into multiple categories, based on predetermined importance criteria;
quantizing K values in a (1-1)th category among the multiple categories with first precision to generate (1-1)th quantized K values, and quantizing K values in a (1-2)th category, which is classified as having lower importance than the (1-1)th category, with second precision lower than the first precision, to generate (1-2)th quantized K values; and
performing attention computation using the (1-1)th quantized K values and the (1-2)th quantized K values.

2. The method of claim 1, wherein in the classifying of the multiple K values, multiple V values stored in the KV cache are classified into multiple categories, based on predetermined importance criteria,
in the quantizing of the K values in the (1-1) the category and (1-2) the category, V values in a (2-1)th category among the multiple categories are quantized with third precision to generate (2-1)th quantized V values, and V values in a (2-2)th category, which is classified as having lower importance than the (2-1)th category, are quantized with fourth precision lower than the third precision to generate (2-2)th quantized V values, and
the attention computation is performed using the (1-1)th quantized K values, the (1-2)th quantized K values, the (2-1)th quantized V values, and the (2-2)th quantized V values.

3. The method of claim 2, wherein the attention computation is performed using K values having multiple types of precision comprising the (1-1)th quantized K values and the (1-2)th quantized K values, and V values having multiple types of precision comprising the (2-1)th quantized V values and the (2-2)th quantized V values.

4. The method of claim 3, wherein the performing of the attention computation comprises:
a first matrix multiplication computation for performing matrix multiplication computation on the K values having multiple types of precision comprising the (1-1)th quantized K values and the (1-2)th quantized K values, and Q values corresponding to the K values;
an activation function execution for executing an activation function on a result value of the first matrix multiplication computation; and
a second matrix multiplication computation for performing matrix multiplication computation on a result value of the activation function and the V values having multiple types of precision comprising the (2-1)th quantized V values and the (2-2)th quantized V values.

5. The method of claim 4, wherein a matrix multiplication function for the first and second matrix multiplication computation performs the matrix multiplication computation on a first input value, which is input as a real value, and a second input value, which is input as an integer value while varying with multiple types of precision.

6. The method of claim 1, wherein the (1-1)th quantized K values are stored in a first cache corresponding to the first precision, and
the (1-2)th quantized K values are stored in a second cache corresponding to the second precision.

7. The method of claim 1, wherein in the quantizing of the K values in the (1-1) the category and (1-2) the category, the quantization is performed by applying a channel balancing value, which is calculated to reduce errors caused by outliers, to the multiple K values.

8. The method of claim 7, wherein the channel balancing value is calculated based on a maximum value among K values and a corresponding maximum value among Q values in each channel.

9. The method of claim 7, wherein in the quantizing of the K values in the (1-1) the category and (1-2) the category, the K values are multiplied by the channel balancing value and then quantized to calculate a first value, and the Q values are divided by the channel balancing value to calculate a second value.

10. The method of claim 9, wherein an inner product of the first value and the second value is performed in the attention computation.

11. The method of claim 1, further comprising reclassifying importance of some or all of the (1-1)th quantized K values in the (1-1)th category.

12. The method of claim 11, wherein based on the reclassification result, some or all of the (1-1)th quantized K values are quantized with the second precision and converted to the (1-2)th quantized K values in the (1-2)th category.

13. A method for managing a KV cache in an attention-based neural network model, the method being performed by a computing device and comprising:
classifying multiple V values stored in the KV cache into multiple categories, based on predetermined importance criteria;
quantizing V values in a (2-1)th category among the multiple categories with third precision to generate (2-1)th quantized V values, and quantizing V values in a (2-2)th category, which is classified as having lower importance than the (2-1)th category, with fourth precision lower than the third precision, to generate (2-2)th quantized V values; and
performing attention computation using the (2-1)th quantized V values and the (2-2)th quantized V values.

14. The method of claim 13, wherein the (2-1)th quantized V values are stored in a third cache corresponding to the third precision, and
the (2-2)th quantized V values are stored in a fourth cache corresponding to the fourth precision.

15. The method of claim 13, further comprising reclassifying importance of some or all of the (2-1)th quantized V values in the (2-1)th category.

16. The method of claim 15, wherein based on the reclassification result, some or all of the (2-1)th quantized V values are quantized with the fourth precision and converted to the (2-2)th quantized V values in the (2-2)th category.

17. A non-transitory computer-readable recording medium storing instructions that, when executed by a processor, cause a computing device to implement operations for managing a KV cache in an attention-based neural network model, the operations comprising:
classifying multiple K values stored in the KV cache into multiple categories, based on predetermined importance criteria;
quantizing K values in a (1-1)th category among the multiple categories with first precision to generate (1-1)th quantized K values, and quantizing K values in a (1-2)th category, which is classified as having lower importance than the (1-1)th category, with second precision lower than the first precision, to generate (1-2)th quantized K values; and
performing attention computation using the (1-1)th quantized K values and the (1-2)th quantized K values.

18. The computer-readable recording medium of claim 17, wherein in the classifying of the multiple K values, multiple V values stored in the KV cache are classified into multiple categories, based on predetermined importance criteria,
in the quantizing of the K values in the (1-1) the category and (1-2) the category, V values in a (2-1)th category among the multiple categories are quantized with third precision to generate (2-1)th quantized V values, and V values in a (2-2)th category, which is classified as having lower importance than the (2-1)th category, are quantized with fourth precision lower than the third precision to generate (2-2)th quantized V values, and
the attention computation is performed using the (1-1)th quantized K values, the (1-2)th quantized K values, the (2-1)th quantized V values, and the (2-2)th quantized V values.
